(19) United States
(12) Patent Application Publication
(10) Pub. No.: US 2024/0023580 A1
(43) Pub. Date: Jan. 25, 2024

(54) USE OF A MIXTURE OF PREGELATINIZED, AMYLOSE-RICH STARCHES HAVING LARGE PARTICLE SIZE AND SOLUBLE FIBERS FOR COATING AND GLAZING BREAKFAST CEREALS

(71) Applicant: ROQUETTE FRERES, Lestrem (FR)

(72) Inventors: André BUSOLIN, Lambersart (FR); Patrice DEMEULEMEESTER, Linselles (FR)

(21) Appl. No.: 18/043,867

(22) PCT Filed: Aug. 19, 2021
(86) PCT No.: PCT/EP2021/025314

§ 371 Date: Mar. 2, 2023

(30) Foreign Application Priority Data
Sep. 2, 2020 (FR) 2008886

(51) Int. Cl. A23L 7/122; A23L 7/135; A23L 7/10; A23L 29/212

(52) U.S. Cl. CPC A23L 7/122; A23L 7/135; A23L 7/115; A23L 29/212

(57) ABSTRACT

The invention relates to the use of a mixture of pregelatinized, amylose-rich starches, having large particle size and soluble fibers, for coating and glazing breakfast cereals, enabling the production of breakfast cereals with a reduced sugar content.

### TECHNICAL FIELD

The present invention relates to the use of a mixture of pregelatinized, amylose-rich starches having large particle size and soluble fibers, for the production of ready-to-eat breakfast cereals with reduced sugar content, more particularly for coating and glazing ready-to-eat breakfast cereals.

The invention relates to the use of a mixture of pregelatinized, amylose-rich starches having large particle size and soluble fibers to replace part of the sucrose contained in coating syrup for ready-to-eat breakfast cereals and/or to reduce the sugar content and in particular the monosaccharide and disaccharide content (% DP1-DP2) of said cereals.

The present invention relates to a method for coating and glazing breakfast cereals in which between 20 to 60%, preferably between 25 and 55%, for example 30% or 50%, by weight of sugars, in particular sucrose, are replaced by a mixture of pregelatinized amylose-rich starches having large particle size and soluble fibers. The invention also relates to ready-to-eat breakfast cereals thus obtained with reduced sugar content.

### PRIOR ART

Ready-to-eat breakfast cereals are popular packaged foods. Thus, the availability, taste and increasing awareness of food and health have made said breakfast cereals a food enjoyed by consumers.

The term “cereals” is used in the rest of the text to mean “ready-to-eat breakfast cereals”.

Cereals exist in a large number of different varieties and can be grouped into different categories, such as puffed and non-puffed cereals, cereals of varying grain origins, presweetened cereals and non-sweetened cereals.

Cereals are also described in terms of forms such as flakes, chips, pillows, squares, puffs, “granola” cereals, etc.

Cereals are finally described in terms of the main grain ingredient from which they come, for example, wheat, rice, corn, oat or other major grains.

Consumers of this type of cereal are also influenced by the properties of the product such as crunchiness, texture, and pleasant mouthfeel.

For example, for snack products with low moisture content, such as cornflakes, crispiness is the main desired texture attribute. Furthermore, the term “crispy” is mentioned more often than any other term when it is a question of the consumption of cereal products for breakfast or snacking.

This is why many products made from dry grains such as breakfast cereals are produced with a crispy texture.

Conventionally, presweetened cereals are prepared in three phases:
1) producing cereals in an unsweetened form;
2) coating with an aqueous suspension (or a solution or syrup) of sweeteners, generally comprising a nutrient sugary sweetener such as sucrose, corn syrup or another sugar syrup, fructose, etc.; then
3) drying the coated pieces in an oven or air stream to remove the moisture added by applying syrup.

For the preparation of presweetened cereals, the sweet coating is applied to cereals (or core cereals) to improve their appearance and to provide softness and flavoring.

Indeed, a coating (i.e. final coating, enlargement or weight increase rate of the products) applied up to 40% on average gives gloss and color and different flavors are possible (cocoa/honey, etc.). Certain vitamins and minerals could also be added to the coating composition to complete the finished product.

The coating is also important when milk is added to the cereals, to color and sweeten the milk. Rapid and partial dissolution of the coating in the milk is necessary.

The traditional grain coating method consists of preparing an “all-in-one” syrup which comprises sucrose, glucose syrups, fats, an emulsifier, flavoring agents and colorants, vitamins and minerals and to spray it onto the cereal pieces in one blast in an open container.

The coated cereals are then dried in several ovens in order to reduce the water content of the finished product. During the drying step, thanks to the evaporation of the water, the sucrose concentration increases to its solubility limit and allows “recrystallization”.

This micro-crystallization on the surface of the cereals is crucial to reduce the stickiness of the cereals, to separate the cereals from one another (no clumps) and to ensure the stability of the finished product (less hygroscopic).

Moreover, as consumers greatly enjoy, this recrystallization at the surface is accompanied by a glazing effect, with the formation of crystals of variable size at the surface of the coating giving this frosted appearance.

In this cereal coating step of the conventional method, sucrose is often selected as the main ingredient of the coating or syrup composition.

However, it is necessary to reduce the content thereof, since the corn syrup and other sucrose-free sugar syrups are often less expensive than sucrose. The manufacturers of food products therefore do not hesitate to replace or substitute at least some of the sucrose with a less expensive carbohydrate or sugar such as corn syrup or another carbohydrate such as a soluble fiber. In addition, consumer trends have leaned toward cereal products with “reduced sugar content”, which in practice can often mean that cereal products contain a relatively reduced amount of sucrose.

But the replacement of sucrose with other “non-sucrose” soluble substances (for example, non-sweetening polysaccharides such as maltodextrins) in a coating can decrease the desired characteristics of the product.

By using a reduced-sugar coating syrup, in particular with reduced sucrose content, in a traditional method, the coated cereals are harder to separate (adhesion between cereals) and a hard and bulky cereal block may be obtained.

The main difficulty consists in substituting a crystalline sugar with an amorphous substitute.

The behavior of the coating syrup or aqueous coating composition is completely different in such a case, being more viscous (higher molecular weight), stickier (no recrystallization), and less stable (more hygroscopic).

Thus, the properties of the various ingredients of the aqueous coating composition must be taken into consideration.

For example, as the amount of sucrose in an aqueous coating composition or coating syrup decreases and the level of a sucrose-free substitute such as corn syrup increases, the coating becomes less crystalline, stickier, and more hygroscopic. Many non-sweetening ingredients such as corn syrup, glucose syrup, honey, molasses and the like are in fact known to exhibit a relatively higher hygroscopicity compared to crystalline sucrose. It is therefore necessary to adapt the method for manufacturing cereals so as to reduce hygroscopicity in order to increase the stability and shelf life of the food product.

Furthermore, some food products containing these substitution products are extremely hygroscopic as a result, and rapidly absorb the moisture of the environment.

Furthermore, the crispiness of food products and in particular cereals must be maintained as long as possible.

However, products containing amorphous sugar (a sweetener less crystallizable than sucrose) have reduced firmness and increased adhesion or stickiness, with increasing moisture content. They will therefore not exhibit the required crispiness.

The viscosity of the aqueous coating composition depends on the physical properties of the surface of the product and environmental parameters such as relative humidity and temperature.

Stickiness is therefore not desirable in the commercial production of breakfast cereals, since otherwise excessively sticky cereal pieces can tend to clump together during treatment and during packaging.

As for the “sugary” perception, it will be even more reduced, as the quantity of sugar in the aqueous coating composition will be reduced.

Another approach for reducing the sucrose level of a ready-to-eat presweetened cereal product consists of adding, instead of the maltodextrins, an agent with a reduced calorie load, such as an intense sweetener or a polyol, to the aqueous coating composition.

Thus, a first solution may consist of reducing the amount of coating and of adding a few intense sweeteners, such as stevia, to compensate. However, the limit of this solution is the taste (i.e. the “off note” of intense sweeteners, such as the metallic aftertaste), the acceptance of the market, and from a technical standpoint, the fact that adding less syrup to cereals impacts the density of the finished product and its behavior in milk (how long it stays good in the bowl).

Another solution could be to substitute crystalline sucrose with a crystalline substitute in the form of polyols (maltitol for example). But because polyols have a laxative effect when consumed in certain amounts, they are not recommended for children. The main market for ready-to-eat cereals is that of children. The acceptance of polyols also depends on the countries.

The breakfast cereal industry is always interested in reducing the sugar content (generally the sucrose) of presweetened breakfast cereals, while maintaining the advantages, the organoleptic properties (glazing effect), and the food qualities of conventional cereal products with high sucrose content.

These new presweetened cereal products or presweetened cereals with reduced sugar contents must
be able to be manufactured in a simple and effective manner,
have an acceptable texture, a preserved “sweet” flavor,
be stable over time,
maintain or exhibit other food qualities,
have a visual appearance at least comparable to the previous cereal products containing standard or reduced levels of sucrose, such as the “frosted” effect on the surface.

The solution which is proposed in the present invention for reducing sugar content in breakfast cereals, while maintaining an glazing effect which gives this frosted appearance, to said cereals, is the use of a mixture comprising pregelatinized, amylose-rich starches having large particle size and soluble fibers for the aqueous coating composition or coating syrup.

By first choosing a pregelatinized starch or pregel to design a formula that makes it possible to efficiently reduce the sugar content of the cereals, the applicant company has overcome a technical prejudice, since said pregel starches are instead recommended in applications where their cold solubility properties are required.

However, in order to limit the adhesion of the cereals and promote the evaporation of the water, it was necessary to have an ingredient which, like sucrose, is easily recrystallizable.

One solution commonly found by a person skilled in the art to solve this difficulty is to instead use another starch derivative, i.e. maltodextrins, as indicated above.

However, this ingredient is increasingly being rejected by consumers since it is too processed (not meeting with the criterion of naturalness, better known in the technical field under the term “Clean label”).

The applicant company then found that, if amylose-rich pregel starches having large particle size are chosen, the properties of the amylose retrogradations could be used to meet the required crystallinity criterion.

Furthermore, the large particle size of the amylose-rich pregel starch contributes more effectively to the frosted appearance imparted by the coating of such a mixture.

Preferably, the amylose-rich starch useful for the present invention is derived from leguminous plants, specifically peas or faba beans.

The term “pea” is considered herein in its broadest sense and including in particular:
all wild varieties of “smooth peas”, and
all mutant varieties of “smooth peas” and “wrinkled peas”, regardless of the uses for which the varieties are generally intended (human food, animal feed and/or other uses).

Said mutant varieties are in particular those called “mutants r”, “mutants rb”, “mutants rug 3”, “mutants rug 4”, “mutants rug 5” and “mutants lam” as described in the article by C-L HEYDLEY et al., entitled “Developing novel pea starches”, Proceedings of the Symposium of the Industrial Biochemistry and Biotechnology Group of the Biochemical Society, 1996, pp. 77-87.

“Faba bean” is understood as the group of annual plants of the species Vicia faba, belonging to the group of leguminous plants of the family Fabaceae, subfamily Faboideae, and tribe Fabeae. A distinction is made between Minor and Major varieties. In the present invention, wild-type varieties and those obtained by genetic engineering or varietal selection are all excellent sources.

“Amylose-rich” starch is understood as a starch having an amylose content of 25% to 45%, of the order of 35% by weight, relative to the total weight of starch.

“Starch” is understood as any composition extracted, in any way whatsoever, from peas or faba beans, and whose starch content is greater than 40%, preferably greater than 50% and even more preferentially greater than 75%, these percentages being expressed in dry weight with respect to the dry weight of said composition.

Advantageously, this starch content is greater than 90% (dry/dry). It may in particular be greater than 95%, including greater than 98%.

In the present invention, the amylose-rich starch useful for the present invention is also a pregelatinized starch.

“Pregelatinized” starch or “pregel” starch is understood to mean a starch obtained by hydrothermal gelatinization treatment of native starches or modified starches, in particular by steam cooking, jet-cooking, drum baking or kneading-machine baking, at a temperature below the gelatinization temperature of the corresponding starch, then drying in starch form on a drying drum or in an extruder, making the starch soluble in cold water.

The pregelatinized or pregel amylose-rich starch useful for the present invention is a starch having large particle size.

Starch “having a large particle size” is understood as a starch containing a particle size determined according to the German standard DIN 66145 dated April 1976 (DIN 66145:1976-04), at an “n” value comprised between 1.7 and 2, preferably of the order of 1.8, and a “d′” value comprised between 850 and 1,000 μm, preferably of the order of 900 μm.

In particular, it is possible to use pregelatinized pea starches sold by the applicant company under the brand name PREGEFLO® L100G.

In the present invention, a mixture comprising pregelatinized amylose-rich starch having large particle size and soluble fibers for the aqueous coating composition or coating syrup is used.

“Soluble” fibers means water-soluble fibers.

For the purposes of the invention, “fibers” more particularly means branched maltodextrins (BMDs) identical to those described in patent EP 1,006,128-B1, of which the Applicant is the proprietor. These BMDs have the advantage of representing a source of indigestible fibers beneficial to metabolism and to intestinal equilibrium.

According to the present invention, said branched maltodextrins are characterized in that they have:
between 15 and 50% of 1-6-glucosidic linkages, preferentially between 22% and 45%, more preferentially between 20% and 40%, and even more preferentially between 25% and 35%,
a reducing sugar content of less than 20%, preferentially between 2% and 20%, more preferentially between 2.5% and 15%, and even more preferentially between 3.5% and 10%,
a polymolecularity index less than 5, preferentially between 1 and 4, more preferentially between 1.5 and 3, and
a number average molecular weight Mn of less than 4500 g/mol, preferentially between 400 and 4500 g/mol, more preferentially between 500 and 3000 g/mol, even more preferentially between 700 and 2800 g/mol, even more preferentially between 1000 and 2600 g/mol.

In particular, BMDs sold by the applicant company under the brand name NUTRIOSE® FM 10 may be used.

A second object of the present invention is the coating syrup or the aqueous coating and glazing composition for ready-to-eat breakfast cereals, characterized in that it comprises from 31% to 51% by weight of sucrose, from 28% to 41% of soluble fibers and from 4% to 21% of pregelatinized amylose-rich starches having large particle size, the % being expressed relative to the total wet weight of the aqueous composition. The variants, details given above for the use of a mixture of pregelatinized amylose-rich starches having large particle size and soluble fibers, are also valid for the aqueous coating composition.

The present invention also relates to a method for manufacturing coated or presweetened ready-to-eat breakfast cereals, characterized in that it comprises the application of the aqueous composition as defined above to breakfast cereals and then the drying of the cereals thus covered, for example in an oven or an air stream to remove the moisture added by the application of the composition.

Another object of the present invention are ready-to-eat coated breakfast cereals obtained using this method, said cereals containing a % DP1-DP2 of 15% to 25%, the % DP1-DP2 representing the % by weight of monosaccharides and disaccharides in the cereals.

Finally, the present invention relates to the use of a mixture of pregelatinized amylose-rich starches having large grain size and soluble fibers as previously defined, in order to replace a portion of the sugars, preferably a portion of the sucrose, contained in a coating syrup or an aqueous coating composition for ready-to-eat breakfast cereals and/or to reduce the % DP1-DP2 of ready-to-eat breakfast cereals, typically by 20 to 60%, preferably by 25 to 55%.

The invention will be better understood with the aid of the following examples, which are intended to be illustrative and non-limiting.

### Example 1. Breakfast Cereal Coating Syrup Formulations with More than 50% Less Sugar

Products Tested:

The tested pregel starches are products manufactured and sold by the Applicant under the brand name PREGEFLO®, and more particularly:
PREGEFLO® L100 G, prepared from pea starch of large particle size; i.e. having, according to the German standard DIN 66145:1976-04, an “n” value comprised between 1.6 and 2, preferentially of the order of 1.8 and a “d′” value comprised between 900 and 1,000 μm, preferentially of the order of 900 μm.
PREGEFLO® C100 G, a control pregel starch, prepared from corn starch, of the same particle size as PREGEFLO® L100 G used in the present invention.

As a “maltodextrin” control, used commonly in the prior art to substitute for sucrose, GLUCIDEX® IT6, a maltodextrin sold by the applicant company, used here instead of pregel starches.

The branched maltodextrin sold by the applicant company under the name NUTRIOSE® FM10 as a water-soluble fiber according to the present invention.

Two other soluble fibers were tested instead of NUTRIOSE: the one sold by TATE & LYLE under the brand name PROMITOR® (SGF) 70R and the one sold by the applicant company under the brand name GLUCIDEX® 21.

The following tables specify the nature of the different formulations of prepared aqueous coating compositions.

TABLE 1

| | | % | | Final | |
|---|---|---|---|---|---|
| | % by | DP1 | Quantities | product | Sugar |
| | dry | and | used | (3% by dry | content |
| Product | weight | DP2 | (g) | weight) | (wt %) |
| Cereal core | 97 | 0 | 259.8 | 61 | 0.0 |
| Coating | 77.3 | 31 | 195.1 | 36 | 16.7 |

Nature of the coating (2.27% PREGEFLO ®)

| | | | | g/100 g | |
|---|---|---|---|---|---|
| | | % | g/100 g | of final | Sugar |
| | | DP1 | of final | product | content |
| | % | and | product | (3% of dry | (g per |
| Ingredients | water | DP2 | (dry) | matter | 100 g) |
| Powder | 0 | 100 | 15.12 | 14.67 | 14.67 |
| sucrose | | | | | |
| PREGEFLO ® | 5 | 1 | 2.27 | 2.20 | 0.02 |
| L100G or | | | | | |
| PREGEFLO ® | | | | | |
| C100G or | | | | | |
| GLUCIDEX ® | | | | | |
| IT6 | | | | | |
| NUTRIOSE ® | 35 | 10 | 20.33 | 19.72 | 1.97 |
| FM10 | | | 37.72 | 100 | 16.7 |

TABLE 2

| | | % | | Final | |
|---|---|---|---|---|---|
| | % by | DP1 | Quantities | product | Sugar |
| | dry | and | used | (3% by dry | content |
| Product | weight | DP2 | (g) | weight) | (wt %) |
| Cereal core | 97 | 0 | 259.8 | 62 | 0.0 |
| Coating | 79.2 | 31.3 | 195.1 | 38 | 16.6 |

Nature of the coating (5% PREGEFLO ®)

| | | | | g/100 g | |
|---|---|---|---|---|---|
| | | % | g/100 g | of final | Sugar |
| | | DP1 | of final | product | content |
| | % | and | product | (3% of dry | (g per |
| Ingredients | water | DP2 | (dry) | matter | 100 g) |
| Powder | 0 | 100 | 15.22 | 14.76 | 14.76 |
| sucrose | | | | | |
| PREGEFLO ® | 5 | 1 | 5.00 | 4.85 | 0.05 |
| L100G or | | | | | |
| PREGEFLO ® | | | | | |
| C100G or | | | | | |
| GLUCIDEX ® | | | | | |
| IT6 | | | | | |
| NUTRIOSE ® | 35 | 10 | 18.39 | 17.84 | 1.78 |
| FM10 | | | | | |
| | | | 38.61 | 100 | 16.6 |

The coating is carried out:
the batches of cereals are prepared which are preheated to 45° C. by drying in air ˜45° C.
the coating syrup or aqueous coating composition is sprayed on rotating cereals (at 80° C.) with an average spraying time of approximately 1.5 to 2 minutes with a Krebs LM3 hotCHOC electric sprayer.
the coating mixture is powdered by manual sprinkling
baking is done at 138° C. for 10 minutes.

Photographs are taken in order to show the visual appearance of the coated cereals thus obtained.

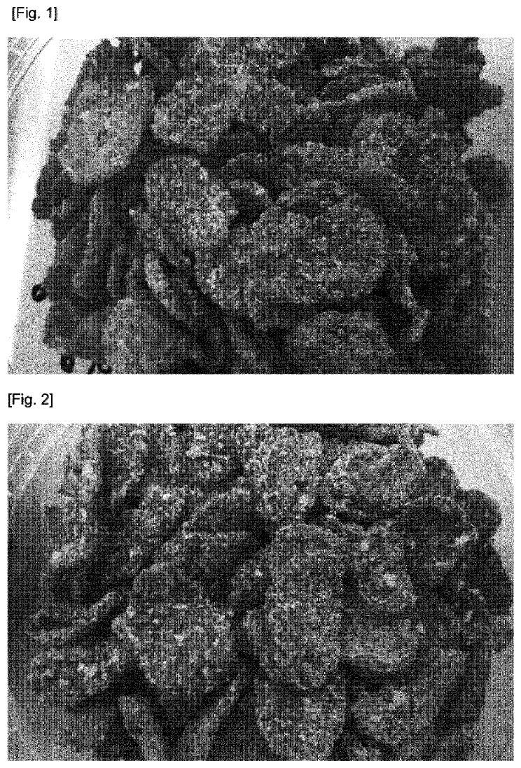

FIG. 1: Mixture of NUTRIOSE® FM 10 (20.33%)+PREGEFLO® L100G (2.27%)

FIG. 2: Mixture of NUTRIOSE® FM 10 (18.39%)+PREGEFLO® L100G (5.00%)

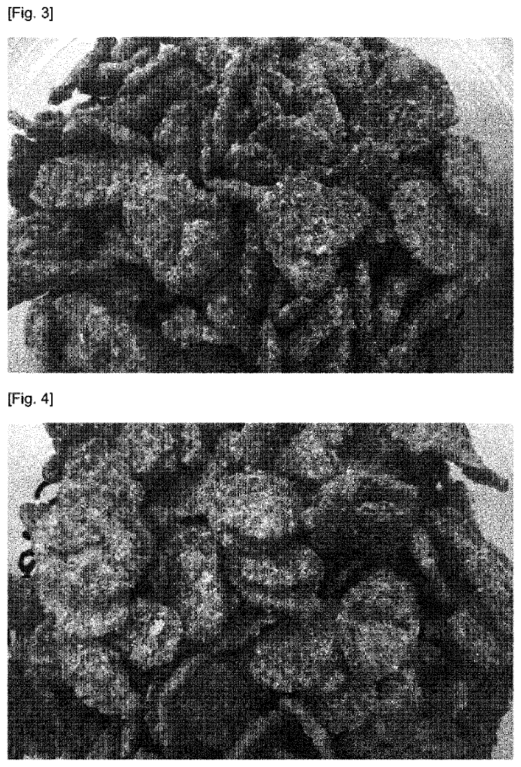

FIG. 3: Mixture of NUTRIOSE® FM 10 (20.33%)+GLUCIDEX® IT6 (2.27%)

FIG. 4: Mixture of NUTRIOSE® FM 10 (20.33%)+PREGEFLO® C100G (2.27%)

The test with 2.27% PREGEFLO® L100G is mat with many small white crystalline structures on the white surface. Doubling the quantity of L100G (5%) increases the number of these small white crystalline structures. The cereal flakes are kept separate and the glazing effect is apparent.

The test with 2.27% PREGEFLO® C100G is also mat but gives cereals whose surface glazing is much less apparent. Pregel starches of corn origin are therefore not suitable for the intended objective.

The test with 2.27% GLUCIDEX® IT6 is similar to that of L100G. This clearly shows that pregel pea starches are a preferred alternative to maltodextrins which meet the specifications, but cannot be selected since they are not accepted by consumers who favor naturalness (“Clean Label”).

Additional tests were carried out, in order to demonstrate the importance of the soluble fibers in the composition of the mixture, and more particularly branched maltodextrins. For this, a conventional soluble fiber (that sold by the company TATE & LYLE under the brand name PROMITOR® was used) (SGF) 70R) and a “negative” control, a maltodextrin sold by the applicant company under the brand name GLUCIDEX® 21.

TABLE 3

| | | % | | Final | |
|---|---|---|---|---|---|
| | % by | DP1 | Quantities | product | Sugar |
| | dry | and | used | (3% by dry | content |
| Product | weight | DP2 | (g) | weight) | (wt %) |
| Cereal core | 97 | 0 | 259.8 | 61 | 0.0 |
| Coating | 77.3 | 31.0 | 195.1 | 36 | 16.7 |

Nature of the coating (5% PREGEFLO ®)

| | | | | g/100 g | |
|---|---|---|---|---|---|
| | | % | g/100 g | of final | Sugar |
| | | DP1 | of final | product | content |
| | % | and | product | (3% of dry | (g per |
| Ingredients | water | DP2 | (dry) | matter | 100 g) |
| Powder | 0 | 100 | 15.12 | 14.67 | 14.76 |
| sucrose | | | | | |
| PREGEFLO ® | 5 | 1 | 2.27 | 2.20 | 0.02 |
| L100G | | | | | |
| GLUCIDEX ® | 35 | 10 | 20.33 | 19.72 | 1.97 |
| 21 | | | | | |
| | | | 37.72 | 100 | 16.7 |

TABLE 4

| | | % | | Final | |
|---|---|---|---|---|---|
| | % by | DP1 | Quantities | product | Sugar |
| | dry | and | used | (3% by dry | content |
| Product | weight | DP2 | (g) | weight) | (wt %) |
| Cereal core | 97 | 0 | 259.8 | 61 | 0.0 |
| Coating | 75.8 | 26.8 | 195.1 | 36 | 16.7 |

Nature of the coating (5% PREGEFLO ®)

| | | | | g/100 g | |
|---|---|---|---|---|---|
| | | % | g/100 g | of final | Sugar |
| | | DP1 | of final | product | content |
| | % | and | product | (3% of dry | (g per |
| Ingredients | water | DP2 | (dry) | matter | 100 g) |
| Powder | 0 | 100 | 13.03 | 12.64 | 12.64 |
| sucrose | | | | | |
| PREGEFLO ® | 5 | 1 | 2.27 | 2.20 | 0.02 |
| L100G | | | | | |
| PROMITOR ® | 35 | 19 | 20.33 | 21.04 | 4.00 |
| | | | 33.37 | 100 | 16.7 |

The coating is carried out in the same way as previously, and photos of the coated cereals produced are also made.

FIG. 5: Mixture of GLUCIDEX® 21 (19.72%)+PREGEFLO® L100G (2.27%)

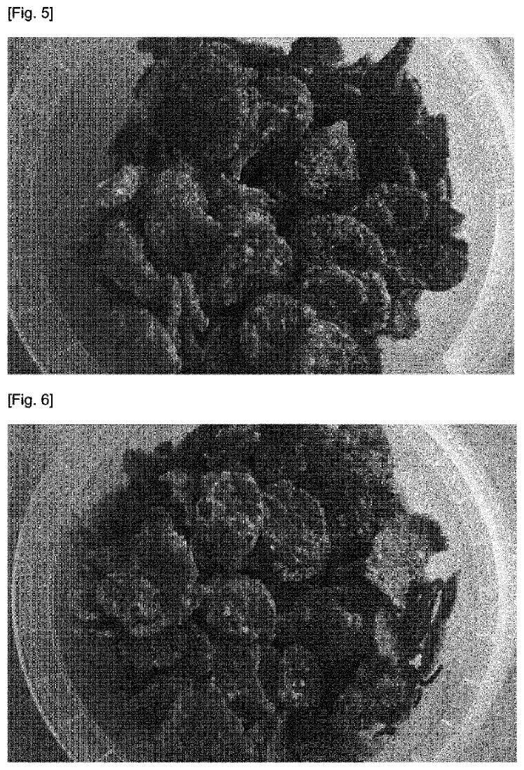

FIG. 6: Mixture of PROMITOR® (SGF) 70R (21.04%)+PREGEFLO® L100G (2.27%).

The solution of GLUCIDEX® 21, which is much too viscous, must be poured by hand.

This also becomes tacky in the oven, probably due to poor distribution of the syrup, but also because of the high viscosity of the solution. As shown in FIG. 5, a frosted effect is achieved.

In conclusion, although the recipe with GLUCIDEX® 21 gives a frosted effect (albeit less than with the recipe with NUTRIOSE® FM10), its viscosity is not suitable for the intended application.

With the solution based on PROMITOR® (SGF) 70R, which can be sprayed using a gun, there is less adhesiveness to the oven (better distribution, lower viscosity), but the frosted effect is light.

In conclusion, although the recipe with GLUCIDEX® 21 gives a frosted effect (less than the recipe with NUTRIOSE® FM10), its viscosity is not suitable for the intended application.

The recipe with the PROMITOR® (SGF) 70R solution gives a slight glazing effect and works well. The soluble fiber is therefore an ingredient well-suited in a mixture with PREGEFLO® pea starch base, PREGEFLO® L100G.

NUTRIOSE® FM10, however, remains the ingredient of choice.

### Example 2. Breakfast Cereal Coating Syrup Formulation with 30% Less Sugar

For a matter of taste, the consumer may demand a smaller reduction in sugar, of the order of 30%.

This example will seek the best recipe to follow to address this issue.

NUTRIOSE® FM10 is retained as a soluble fiber. There are different PREGEFLO® L100G contributions+a control without PREGEFLO® (which makes it possible, in this case, to measure the contribution of the single soluble fiber in the coating)+a control where the NUTRIOSE FM® 10 is replaced with a glucose syrup sold by the applicant company, which has a content of monosaccharides and disaccharides (DP1 and DP2) similar to NUTRIOSE® FM 10. This in order to measure the role played by the fiber component of NUTRIOSE® FM10.

TABLE 5

| | | % | | Final | |
|---|---|---|---|---|---|
| | % by | DP1 | Quantities | product | Sugar |
| | dry | and | used | (3% by dry | content |
| Product | weight | DP2 | (g) | weight) | (wt %) |
| Cereal core | 97 | 0 | 259.8 | 61 | 0.0 |
| Coating | 77.7 | 56.4 | 195.1 | 36 | 25.9 |

Nature of the coating (50/50 NUTRIOSE ®
Sucrose + 2.27% PREGEFLO ®)

| | | | | g/100 g | |
|---|---|---|---|---|---|
| | | % | g/100 g | of final | Sugar |
| | | DP1 | of final | product | content |
| | % | and | product | (3% of dry | (g per |
| Ingredients | water | DP2 | (dry) | matter | 100 g) |
| Powder | 0 | 100 | 15.71 | 15.24 | 15.24 |
| sucrose | | | | | |
| PREGEFLO ® | 5 | 1 | 2.27 | 2.20 | 0.02 |
| L100G | | | | | |
| NUTRIOSE ® | 35 | 55 | 19.95 | 19.35 | 10.64 |
| FM10 | | | | | |
| | | | 37.92 | 100 | 25.9 |

TABLE 6

| | | % | | Final | |
|---|---|---|---|---|---|
| | % by | DP1 | Quantities | product | Sugar |
| | dry | and | used | (3% by dry | content |
| Product | weight | DP2 | (g) | weight) | (wt %) |
| Cereal core | 97 | 0 | 259.8 | 61 | 0.0 |
| Coating | 75.3 | 46.1 | 195.1 | 36 | 25.9 |

Nature of the coating (50/50 NUTRIOSE ®/Sucrose)

| | | | | g/100 g | |
|---|---|---|---|---|---|
| | | % | g/100 g | of final | Sugar |
| | | DP1 | of final | product | content |
| | % | and | product | (3% of dry | (g per |
| Ingredients | water | DP2 | (dry) | matter | 100 g) |
| Powder | 0 | 100 | 14.41 | 13.98 | 13.98 |
| sucrose | | | | | |
| NUTRIOSE ® | 35 | 55 | 34.37 | 21.67 | 11.92 |
| FM10 | | | | | |
| | | | 37.92 | 100 | 25.9 |

TABLE 7

| | | % | | Final | |
|---|---|---|---|---|---|
| | % by | DP1 | Quantities | product | Sugar |
| | dry | and | used | (3% by dry | content |
| Product | weight | DP2 | (g) | weight) | (wt %) |
| Cereal core | 97 | 0 | 259.8 | 61 | 0.0 |
| Coating | 80.5 | 74.4 | 195.1 | 36 | 25.9 |

Nature of the coating (50/50 NUTRIOSE ®/
Sucrose + 5% PREGEFLO ®)

| | | | | g/100 g | |
|---|---|---|---|---|---|
| | | % | g/100 g | of final | Sugar |
| | | DP1 | of final | product | content |
| | % | and | product | (3% of dry | (g per |
| Ingredients | water | DP2 | (dry) | matter | 100 g) |
| Powder | 0 | 100 | 17.06 | 16.55 | 16.55 |
| sucrose | | | | | |
| PREGEFLO ® | 5 | 1 | 5.00 | 4.85 | 0.05 |
| L100G | | | | | |
| NUTRIOSE ® | 35 | 55 | 17.19 | 16.68 | 9.30 |
| FM10 | | | | | |
| | | | 39.26 | 100 | 25.9 |

TABLE 8

| | | % | | Final | |
|---|---|---|---|---|---|
| | % by | DP1 | Quantities | product | Sugar |
| | dry | and | used | (3% by dry | content |
| Product | weight | DP2 | (g) | weight) | (wt %) |
| Cereal core | 97 | 0 | 259.8 | 61 | 0.0 |
| Coating | 77.7 | 56.4 | 195.1 | 36 | 25.9 |

Nature of the coating (50/50 glucose syrup
4779/Sucrose + 2.27% PREGEFLO ®)

| | | | | g/100 g | |
|---|---|---|---|---|---|
| | | % | g/100 g | of final | Sugar |
| | | DP1 | of final | product | content |
| | % | and | product | (3% of dry | (g per |
| Ingredients | water | DP2 | (dry) | matter | 100 g) |
| Powder | 0 | 100 | 15.71 | 15.24 | 15.24 |
| sucrose | | | | | |
| PREGEFLO ® | 5 | 1 | 2.27 | 2.20 | 0.02 |
| L100G | | | | | |
| Glucose | 35 | 55 | 19.95 | 19.35 | 10.64 |
| syrup 4779 | | | | | |
| | | | 37.92 | 100 | 25.9 |

The coating is carried out in the same way as previously, and photos of the coated cereals produced are also made.

FIG. 7: Mixture 50/50 NUTRIOSE®/SUCROSE+2.27% PREGEFLO® L100G

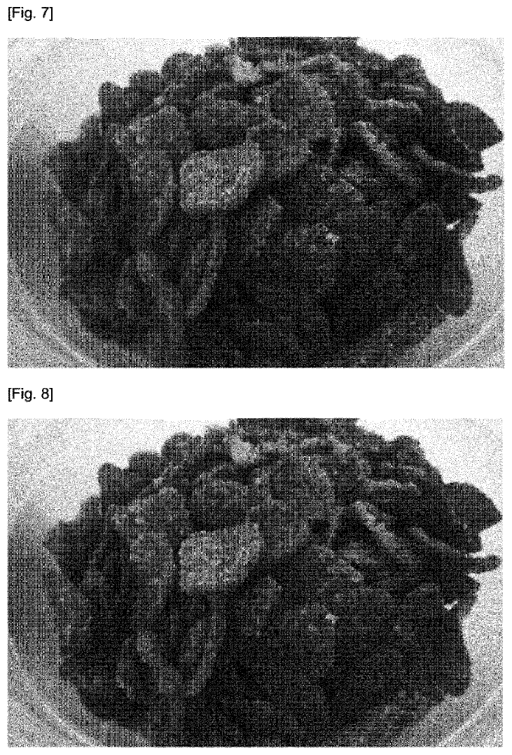

FIG. 8: Mixture 50/50 NUTRIOSE®/SUCROSE

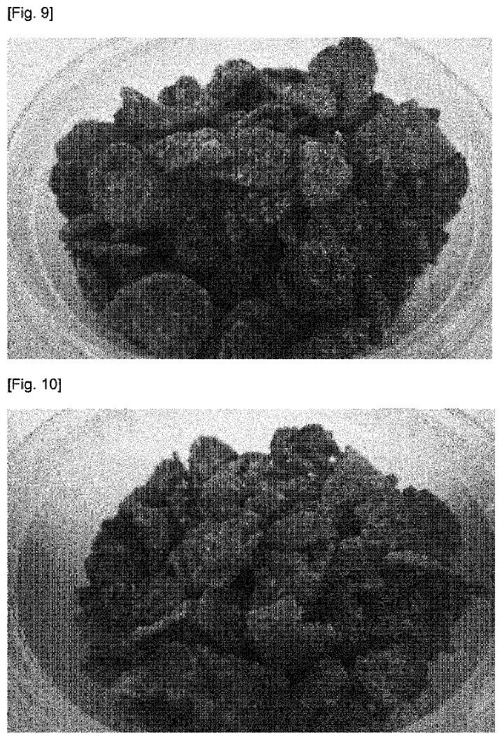

FIG. 9: Mixture 50/50 NUTRIOSE®/SUCROSE+5% PREGEFLO® L100G

FIG. 10: Mixture 50/50 Glucose syrup 4779/SUCROSE+2.27% PREGEFLO® L100G

Visually, the cereal flakes obtained generally have a light glazing effect on the surface, except when the coating composition contains 5% PREGEFLO® 100G.

Compared to a 50% sugar reduction as in Example 1, it is more difficult to crystallize here the dissolved sucrose in the coating composition and the surface is stickier.

This is due to sugar in the syrup that remains in an amorphous, non-crystalline state and that provides more hygroscopicity to the product and more stickiness.

The formulas with glucose syrup or NUTRIOSE® do not meet expectations.

Under these conditions, for a recipe with a 30% sugar reduction, it is necessary to preferably choose the recipe with 5% PREGEFLO® L100G which gives a surface state equivalent to 2.27% PREGEFLO® L100G for a 50% reduction.

1. A use of a mixture of pregelatinized, amylose-rich starches having large particle size and soluble fibers for coating and glazing ready-to-eat breakfast cereals.

2. The use according to claim 1, wherein the amylose-rich starch is derived from leguminous plants, more particularly from peas or faba beans.

3. The use according to a claim 1, wherein the amylose content of the starch is comprised between 25% and 45%, preferably of the order of 35% by total weight of starch.

4. The use according to claim 1, wherein the particle size of the starch, determined according to the German standard DIN 66145, has an “n” value comprised between 1.7 and 2, preferably of the order of 1.8 and a “d′” value comprised between 850 and 1,000 μm, preferably of the order of 900 μm.

5. The use according to claim 1, wherein the soluble fibers are water-soluble fibers, more particularly branched maltodextrins having:
between 15 and 50% of 1-6-glucosidic linkages, preferentially between 22% and 45%, more preferentially between 20% and 40%, and even more preferentially between 25% and 35%;
a reducing sugar content of less than 20%, preferentially between 2% and 20%, more preferentially between 2.5% and 15%, and even more preferentially between 3.5% and 10%;
a polymolecularity index less than 5, preferentially between 1 and 4, more preferentially between 1.5 and 3; and,
a number average molecular weight Mn of less than 4500 g/mol, preferentially between 400 and 4500 g/mol, more preferentially between 500 and 3000 g/mol, even more preferentially between 700 and 2800 g/mol, even more preferentially between 1000 and 2600 g/mol.

6. An aqueous coating and glazing composition for ready-to-eat breakfast cereals, wherein the composition comprises from 31% to 51% by weight of sucrose, from 28% to 41% of soluble fibers and from 4% to 21% of pregelatinized amylose-rich starches having large particle size, the % being expressed relative to the total wet weight of the aqueous composition.

7. The composition according to claim 6, wherein the pregelatinized amylose-rich starch is derived from leguminous plants, more particularly from peas or faba beans.

8. The composition according to claim 6, wherein the amylose content of the starch is comprised between 25% and 45%, preferably of the order of 35% by total weight of starch.

9. The composition according to claim 6, wherein the particle size of the starch, determined according to the German standard DIN 66145, has an “n” value comprised between 1.7 and 2, preferably of the order of 1.8 and a “d′” value comprised between 850 and 1,000 μm, preferably of the order of 900 μm.

10. The composition according to claim 6, wherein the soluble fibers are water-soluble fibers, more particularly branched maltodextrins having:
between 15 and 50% of 1-6-glucosidic linkages, preferentially between 22% and 45%, more preferentially between 20% and 40%, and even more preferentially between 25% and 35%;
a reducing sugar content of less than 20%, preferentially between 2% and 20%, more preferentially between 2.5% and 15%, and even more preferentially between 3.5% and 10%;
a polymolecularity index less than 5, preferentially between 1 and 4, more preferentially between 1.5 and 3; and,
a number average molecular weight Mn of less than 4500 g/mol, preferentially between 400 and 4500 g/mol, more preferentially between 500 and 3000 g/mol, even more preferentially between 700 and 2800 g/mol, even more preferentially between 1000 and 2600 g/mol.

11. A method for manufacturing ready-to-eat coated breakfast cereals, wherein the method comprises the application of an aqueous composition as defined in claim 6 to breakfast cereals and then drying the cereals thus covered, for example in an oven or an air stream, to remove the moisture added by applying the composition.

12. Ready-to-eat coated breakfast cereals obtained using the method according to claim 11, wherein they contain a % DP1-DP2 of 15% to 25%, the % DP1-DP2 representing the % by weight of monosaccharides and disaccharides in the cereals.

13. A use of a mixture of pregelatinized amylose-rich starches having large particle size and soluble fibers as defined in claim 1, for replacing some of the sugars, preferably a portion of the sucrose, contained in an aqueous coating composition for ready-to-eat breakfast cereals and/or for reducing the % DP1-DP2 of ready-to-eat breakfast cereals.

14. The use according to claim 13, wherein the use of the mixture of pregelatinized amylose-rich starches having large particle size and soluble fibers makes it possible to reduce the DP1 DP2% of ready-to-eat breakfast cereals from 20 to 60%, preferably from 25 to 55%.
